(19) United States
(12) Patent Application Publication
(10) Pub. No.: US 2009/0307082 A1
(43) Pub. Date: Dec. 10, 2009

(54) SYSTEM AND METHOD FOR WEB ADVERTISEMENT

(75) Inventors: Vijay Raghunathan, San Francisco, CA (US); Jian Shen, East Palo Alto, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Meebo Inc.

(21) Appl. No.: 12/480,671

(22) Filed: Jun. 8, 2009

Related U.S. Application Data
(60) Provisional application No. 61/059,700, filed on Jun. 6, 2008.

(51) Int. Cl. G06Q 30/00; G06Q 10/00

(52) U.S. Cl. 705/14.44; 705/14.52

(57) ABSTRACT

A method and system for web advertisement are disclosed. According to one embodiment a computer-implemented method comprises receiving chat room information, wherein the chat room information describes a current state of a chat room. The chat room information is provided to an advertisement server, and the advertisement server selects an advertisement based upon the chat room information. The advertisement is received and provided to an advertisement module, and the advertisement module provides the advertisement to the chat room.

The present application claims the benefit of and priority to U.S. Provisional Patent Application No. 61/059,700 entitled “Web Advertisement Systems” filed on Jun. 6, 2008, and is hereby, incorporated by reference.

### FIELD

The present invention relates generally to the field of computer applications and, more specifically, to web advertisement.

### BACKGROUND

Existing web advertisement (ad) systems are designed for the model of a single-user viewing an individual ad. Multiple users do not and cannot view the same ad at the same time, similar to how broadcast television displays ads. Viewing the same ad at the same time can allow users to discuss reactions to an ad in real time. Having multiple users view an ad at the same time and post reactions can help an advertiser provide relevant content to a group of users.

### SUMMARY

A method and system for web advertisement are disclosed. According to one embodiment a computer-implemented method comprises receiving chat room information, wherein the chat room information describes a current state of a chat room. The chat room information is provided to an advertisement source, and the advertisement source selects an advertisement based upon the chat room information. The advertisement is received and provided to an advertisement injector, and the advertisement injector provides the advertisement to the chat room.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary computer architecture for use with the present system, according to one embodiment.

FIG. 2 illustrates an exemplary system level layout for a web advertisement system, according to one embodiment.

FIG. 3A illustrates an exemplary flow diagram for access by a non-anonymous user within a web advertisement system, according to one embodiment.

FIG. 3B illustrates an exemplary flow diagram for access by an anonymous user within a web advertisement system, according to one embodiment.

FIG. 4 illustrates communication with an ads scheduler within a web advertisement system, according to one embodiment.

FIG. 5A is a diagram of exemplary ad injection within a web advertisement system, according to one embodiment.

FIG. 5B illustrates an exemplary flow diagram for an ad injection process within a web advertisement system, according to one embodiment.

FIG. 6A illustrates an exemplary user interface within a web advertisement system, according to one embodiment.

FIG. 6B illustrates an exemplary user interface within a web advertisement system, according to one embodiment.

FIG. 6C illustrates an exemplary user interface within a web advertisement system, according to one embodiment.

### DETAILED DESCRIPTION

A method and system for web advertisement are disclosed. According to one embodiment a computer-implemented method comprises receiving chat room information, wherein the chat room information describes a current state of a chat room. The chat room information is provided to an advertisement source, and the advertisement source selects an advertisement based upon the chat room information. The advertisement is received and provided to an advertisement injector, and the advertisement injector provides the advertisement to the chat room.

The present system allows multiple users in the same discussion context to view the same ad at the same time. The discussion contexts can exist across multiple web pages or can exist as the form of an embedded chat room. The present system dictates the kind of advertising that is served based on a real time aggregate profile of the participants in the room, allows all participants in the room to view the same ad at the same time.

The present system provides a real-time behavioral ad. Ads are pushed into the discussion context via an ad scheduler where the ad scheduler is already aware of the participants in the room and where they are on the web.

The present system includes an ad scheduler, an ad injector and a client. According to a predefined period, the ad scheduler iterates over a list of chat rooms that contain active users and selects an ad to be displayed. The selection process may use targeting information to show the most appropriate ad. Additionally, the ad scheduler may opt to show the most valuable ad or content in the largest or most active room or according to other behavior in a discussion. The ad scheduler passes the ad to an ad injector which is responsible for formatting the ad and broadcasting it to all the room participants. The ad broadcast message is authenticated by the chat room server so that only an authorized set of users may inject ads. The client system receives the ad message, fetches and displays the described ad content. The client additionally performs some heuristics to determine whether or not the user has been active. Additionally, the present system takes into account the rate of messages in the room to ensure that inactive rooms are not overwhelmed by advertisements.

The present system dictates the kind of advertising that is served based on a real time aggregate profile of the participants in the room. For ad buyers, this provides the flexibility to decide if an ad gets shown based on thresholds of participation and behavior so the risk to buy can be significantly lower. As an example, if a discussion is started on an English web page for the topic of Soccer, an ad buyer may target English as a language and Soccer as a keyword. If the discussion is then copied to a Spanish web page and the discussion takes off completely in Spanish, the ads won't be served because the aggregate profile of the room has changed.

The present system allows all participants in the room to view the same ad at the same time. By broadcasting ads in a medium where users are already talking, the system encourages users to discuss the ad content. In doing this, the advertisements serve more as topics of discussion than interruptions like prior art web advertisements. The users are enticed to view the ad content and interact if the ad is effective and relevant.

The present system immediately posts reactions to the advertisement when users click through them, talk about them, sharing them, or even directly notifying the advertisers in real time that they are interested in the advertised product or brand.

The present system provides the opportunity for the effectiveness and performance of an ad to be measured by click-throughs, reactions, interactions and sharing. Advertisers can see in real time how well ads perform and even create ads that respond to the behavior of the users in the room.

A real time behavioral ad can be based on, for example, the number of people in a room who volunteer their interest in a particular music artist. After so many people participate, sponsored content from the ad provider can then be injected into the room based on that behavior, like a free ring tone or mp3 song.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

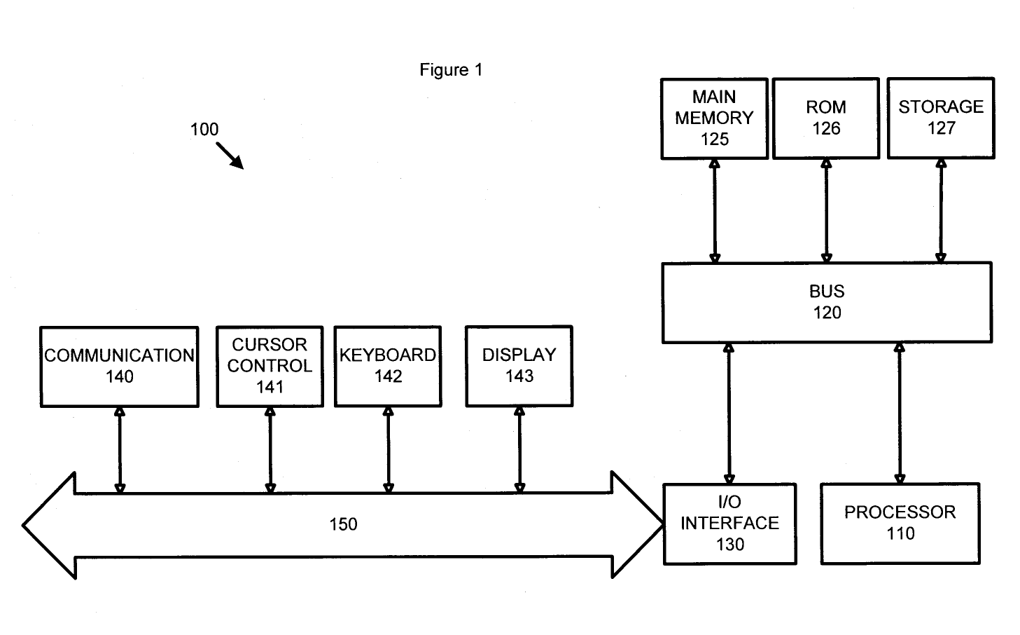

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

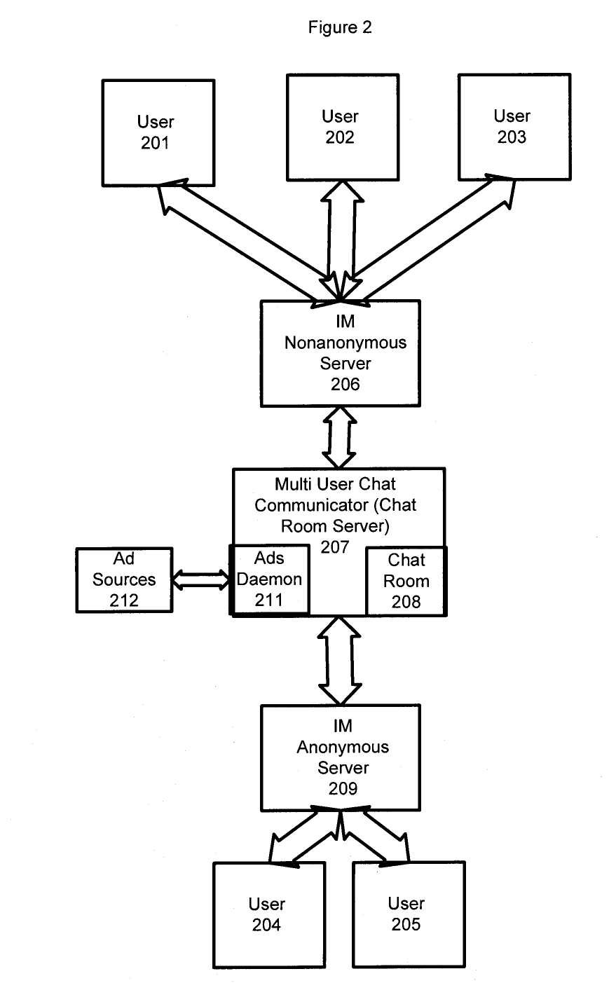

FIG. 2 illustrates an exemplary system level layout for a web advertisement system, according to one embodiment. A non-anonymous instant messaging (IM) server 206 (for example, a Jabber server) communicates with multiple users, for example users 201, 202, and 203. The non-anonymous IM server 206 is in communication with a multi-user chat communicator that maintains a state of a chat room and resides on a chat room server 207. An example of a state of a chat room includes whether the room is active and how many participants are in the room. The chat room server 207 includes an ads daemon (or ads scheduler) 211 and hosts a chat room 208. The ads daemon 211 communicates with ad sources 212. An anonymous IM server 209 is also in communication with the multi user chat communicator 207 as well as one or more users, for example users 204 and 205. According to one embodiment, a web advertisement system can include multiple chat servers, each chat server having an ad daemon.

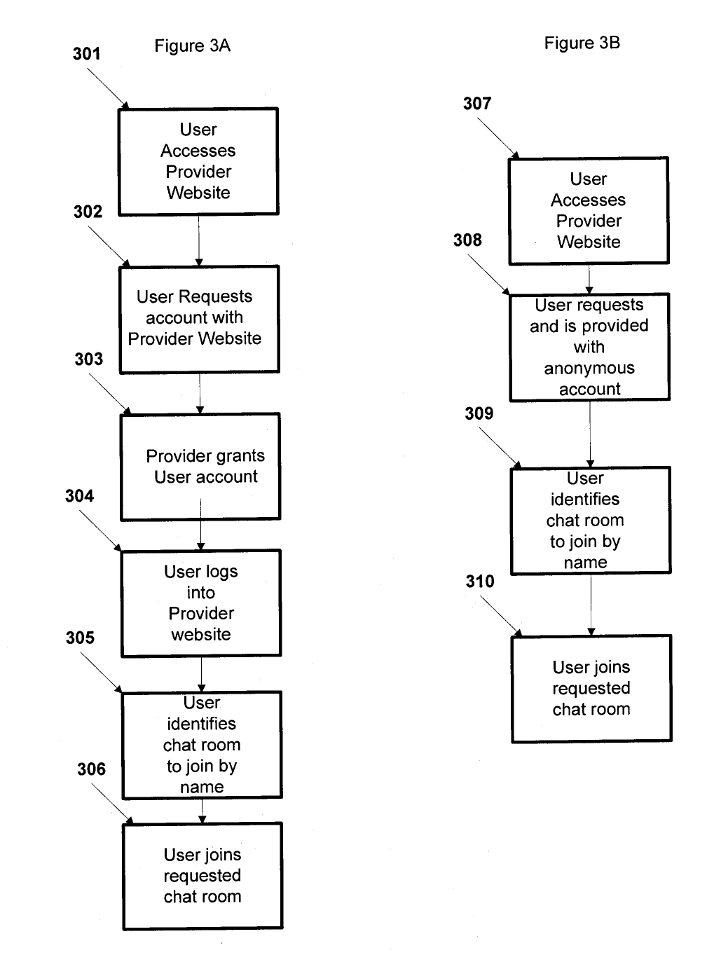

FIG. 3A illustrates an exemplary flow diagram for access by a non-anonymous user within a web advertisement system, according to one embodiment. A user accesses a provider website 301 and requests an account 302. A provider website is hosted by a provider server, the provider server hosts modules to deliver chat room functionality to clients. The provider grants an account to the user 303 and the user is able to log into the provider website accordingly 304. The user can identify a chat room to join by name 305 and subsequently join the requested chat room 306.

FIG. 3B illustrates an exemplary flow diagram for access by an anonymous user within a web advertisement system, according to one embodiment. A user accesses a provider website 307 and is provided with an anonymous account 308. The user can identify a chat room to join by name 309 and subsequently join the requested chat room 310.

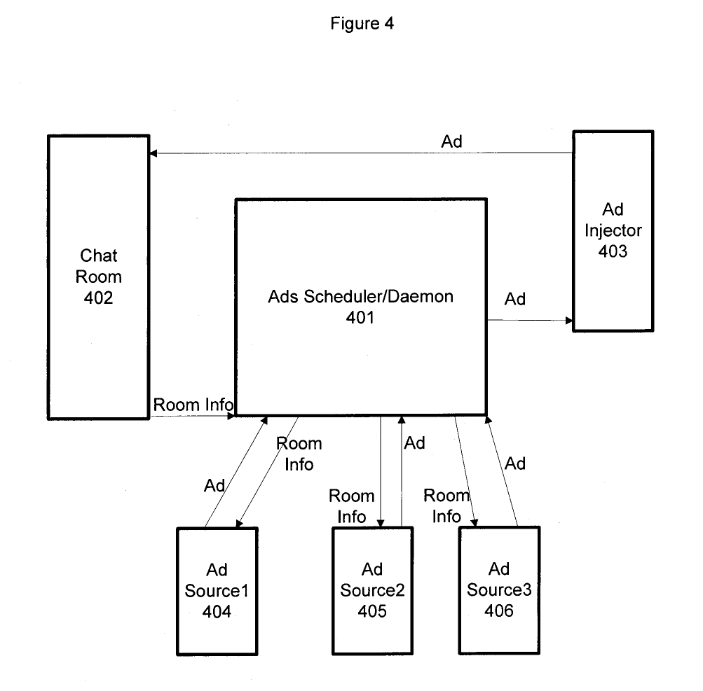

FIG. 4 illustrates communication with an ad scheduler within a web advertisement system, according to one embodiment. An ad scheduler (or ad daemon) 401 periodically polls existing chat rooms, including chat room 402 to collect room information. In one embodiment, the period between polls of chat rooms by the ad scheduler 401 is configurable. Room information includes but is not limited to the number of active users participating in the room, profiles of the users participating in the room (for example age, gender, geographic location, language preference), time between displayed ads (how much time has lapsed since the last ad was displayed), discussion within the room, discussion of current or previously displayed ads. The ad scheduler 401 collects room information from the chat room 402 and provides the room information to ad sources, for example ad source1 404, ad source2 405, and ad source3 406. According to one embodiment, the ad scheduler reviews whether a revenue agreement is in place for particular ads. The ad scheduler 401 receives ads from the ad sources based upon analysis of the provided room information and send the ad to an ad injector 403 (or ad module). The ad injector 403 injects the ad into the chat room 402. The ad sources can receive individual pieces of room information, for example one ad source may receive age and gender and return ads based upon the information while another ad source receives texts or keywords and returns appropriate ads. According to one embodiment, room information regarding whether a user is active or inactive includes but is not limited to recent typing or discussion contribution, and mouse clicks.

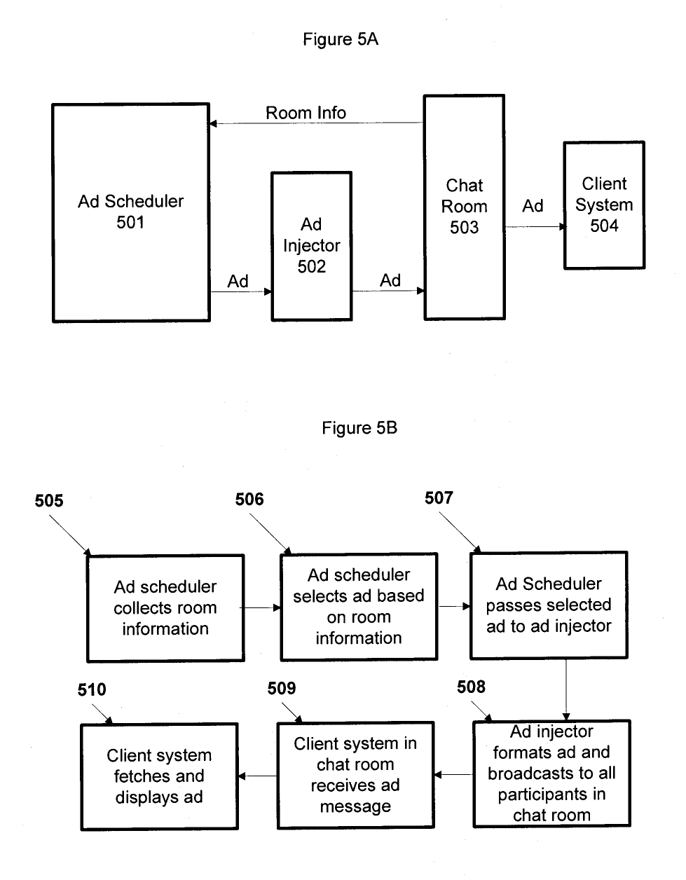

FIG. 5A is a diagram of exemplary ad injection within a web advertisement system, according to one embodiment. An ad scheduler 501 periodically receives room information from a chat room 503 and provides an appropriate ad to an ad injector 502 based upon the received room information. The ad injector 502 broadcasts the ad to all participants in a chat room 503, and a client system 504 of a user participating in the chat room 503 fetches and displays the ad to the user.

FIG. 5B illustrates an exemplary flow diagram for an ad injection process within a web advertisement system, according to one embodiment. An ad scheduler collects room information 505, and selects an ad based on the room information 506. The ad scheduler passes the selected ad to an ad injector 507. The ad injector formats the ad and broadcasts it to all participants in a chat room 508. A client system in a chat room receives the ad message 509 broadcast by the ad injector. The client system fetches and displays the ad to the user 510.

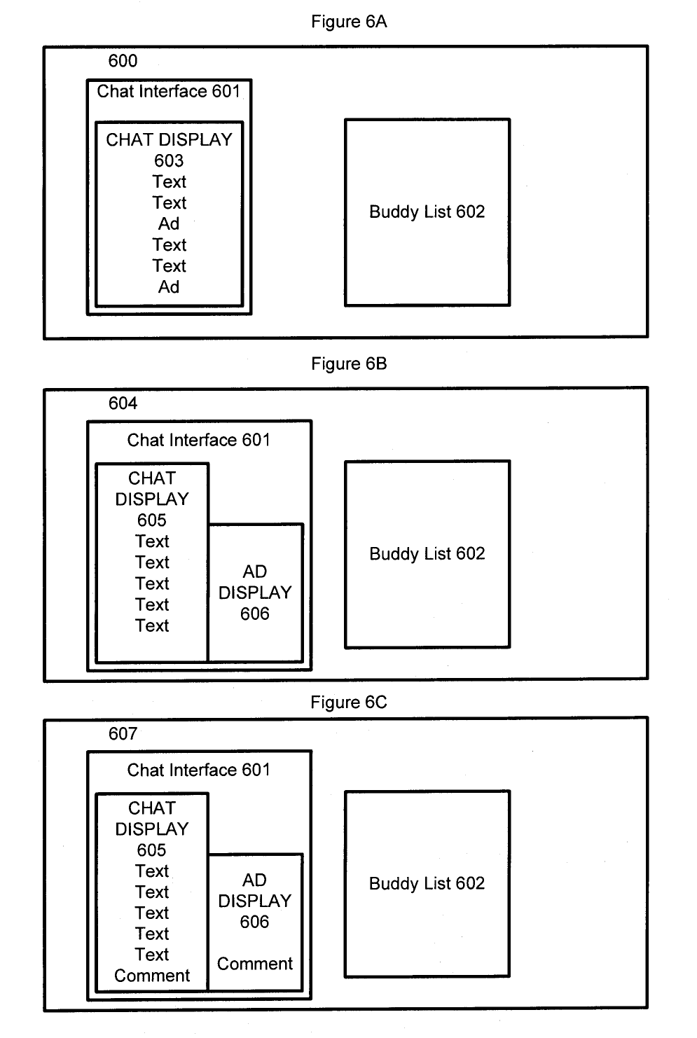

FIG. 6A illustrates an exemplary user interface within a web advertisement system, according to one embodiment. An exemplary user interface 600 may include a chat interface 601 and a buddy list 602. A chat display 603 within the chat interface 601 displays discussion text within the chat room and displayed ads. According to one embodiment a fixed number of lines of text between displayed ads can be designated so that multiple ads are not displayed at the same time. According to another embodiment a user may click on the ad to expand for a larger display.

FIG. 6B illustrates an exemplary user interface within a web advertisement system, according to one embodiment. An exemplary user interface 604 includes a chat interface 601 and a buddy list 602. A chat display 605 within the chat interface 601 displays discussion text within the chat room and a separate ad display 606 displays ads.

FIG. 6C illustrates an exemplary user interface within a web advertisement system, according to one embodiment. An exemplary user interface 607 includes a chat interface 601 and a buddy list 602. A chat display 605 within the chat interface 601 displays discussion text within the chat room and a separate ad display 606 displays ads. The ad display 606 includes an area for users to provide comments on the displayed ad, and the comments are echoed into the chat display 605.

A method and system for web advertisement are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer-implemented method, comprising:
receiving chat room information, wherein the chat room information describes a current state of a chat room;
providing the chat room information to an advertisement server, wherein the advertisement server selects an advertisement based upon the chat room information;
receiving the advertisement; and
providing the advertisement to an advertisement module, wherein the advertisement module provides the advertisement to the chat room.

2. The computer-implemented method of claim 1, wherein the chat room information includes one or more of: number of active chat room participants, location of chat room participants, designated chat room language, chat room participant profiles, elapsed time between displayed advertisements, discussion of currently displayed advertisements, chat room text, and discussion of previously displayed advertisements.

3. The computer-implemented method of claim 1, wherein the advertisement module provides the advertisement periodically.

4. The computer-implemented method of claim 1, wherein the advertisement module further formats the advertisement and broadcasts the advertisement to all clients in the chat room.

5. A system, comprising:
a provider server, the provider server having a chat room and an advertisement scheduler;
an instant messaging server in communication with the provider server;
one or more users in communication with the instant messaging server; and
an advertisement server in communication with the advertisement scheduler, wherein the advertisement scheduler:
receives chat room information, wherein the chat room information describes a current state of a chat room;
provides the chat room information to the advertisement server, wherein the advertisement server selects an advertisement based upon the chat room information;
receives the advertisement; and
provides the advertisement to an advertisement module, wherein the advertisement module provides the advertisement to the chat room.

6. The system of claim 5, wherein the chat room information includes one or more of: number of active chat room participants, location of chat room participants, designated chat room language, chat room participant profiles, elapsed time between displayed advertisements, discussion of currently displayed advertisements, chat room text, and discussion of previously displayed advertisements.

7. The system of claim 5, wherein the advertisement module provides the advertisement periodically.

8. The system of claim 5, wherein the advertisement module further formats the advertisement and broadcasts the advertisement to all clients in the chat room.

9. A computer-implemented method, comprising:
accessing a provider server;
submitting a request to join a chat room;
participating in a chat room discussion, wherein the chat room discussion comprises text; and
receiving an advertisement wherein the advertisement is selected based on chat room information and the text.

10. The computer-implemented method of claim 9, wherein the advertisement is provided to all clients of the chat room simultaneously.

11. The computer-implemented method of claim 9, wherein the chat room information includes one or more of: number of active chat room participants, location of chat room participants, designated chat room language, chat room participant profiles, elapsed time between displayed advertisements, discussion of currently displayed advertisements, and discussion of previously displayed advertisements.

12. A system, comprising:
a provider server, the provider server having a chat room and an advertisement scheduler;
an instant messaging server in communication with the provider server;
an advertisement server in communication with the advertisement scheduler; and
one or more clients in communication with the instant messaging server, wherein
a user of the one or more clients:
accesses the provider server;
submits a request to join a chat room;
participates in a chat room discussion, wherein the chat room discussion comprises text; and
receives an advertisement wherein the advertisement is selected based on chat room information and the text.

13. The system of claim 12, wherein the chat room information includes one or more of: number of active chat room participants, location of chat room participants, designated chat room language, chat room participant profiles, elapsed time between displayed advertisements, discussion of currently displayed advertisements, and discussion of previously displayed advertisements.
